(19) United States
(12) Patent Application Publication
(10) Pub. No.: US 2025/0177880 A1
(43) Pub. Date: Jun. 5, 2025

(54) JOINT RESTRAINT SYSTEM FOR AN ANIMATED FIGURE

(71) Applicant: Universal City Studios LLC, Universal City, CA (US)

(72) Inventors: Timothy Fitzgerald Garnier, Orlando, FL (US); Aaron Chandler Jeromin, Winter Garden, FL (US); Akiva Meir Krauthamer, Ocoee, FL (US); Eric Ross Boxer, Clermont, FL (US)

(21) Appl. No.: 18/525,529

(22) Filed: Nov. 30, 2023

(51) Int. Cl. A63J 19/00; F16D 63/00

(52) U.S. Cl. CPC A63J 19/006; F16D 63/00

(57) ABSTRACT

An animated figure includes an appendage having a joint. The animated figure also includes a joint restraint device coupled to the appendage. The joint restraint device includes a membrane defining an internal volume and granules disposed within the internal volume. Additionally, the joint restraint device is configured to compact the granules against each other to restrain motion of the joint in response to a vacuum pressure applied to the membrane.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues contain, among many other attractions, animated figures (e.g., robots) to entertain park guests that are queued for or within a ride experience. Certain animated figures may include members (e.g., appendages) coupled via movable joints (e.g., knees) and controlled by actuators (e.g., motors, pistons). The actuators may provide mechanical power to maintain the members and the movable joints in desired positions (e.g., poses).

### SUMMARY

Certain embodiments commensurate in scope with the present disclosure are summarized below. These embodiments are not intended to limit the scope of the disclosure, but rather these embodiments are intended only to provide a brief summary of possible forms of present embodiments. Indeed, present embodiments may encompass a variety of forms that may be similar to or different from the embodiments set forth below.

In an embodiment, an animated figure includes an appendage having a joint and a joint restraint device coupled to the appendage. The joint restraint device includes a membrane defining an internal volume and a plurality of granules disposed within the internal volume. The joint restraint device is configured to compact the plurality of granules against each other to restrain motion of the joint in response to a vacuum pressure applied to the membrane.

In an embodiment, a joint restraint device for an animated figure includes a membrane defining an internal volume. The joint restraint device also includes a conduit configured to fluidly couple the internal volume to a vacuum source. Additionally, the joint restraint device includes a valve configured to selectively open an air flow path between the internal volume and the vacuum source via the conduit. The joint restraint device further includes granules disposed within the internal volume of the membrane. The granules are configured to compact against each other to form a relatively rigid body in response to a vacuum pressure applied to the internal volume.

In an embodiment, an appendage control system for an animated figure includes actuators configured to move members about a joint. The appendage control system also includes joint restraint devices, each having a membrane defining an internal volume. Each joint restraint device also includes granules disposed within the internal volume, wherein the granules are configured to form a relatively rigid body around a respective joint in response to a vacuum pressure applied to the internal volume.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an attraction system that includes an animated figure, in accordance with embodiments of the present disclosure;

FIG. 2 is a schematic of an appendage of an animated figure, in accordance with embodiments of the present disclosure;

FIG. 3 is a schematic of an appendage of an animated figure, wherein the appendage is in an operating state, in accordance with embodiments of the present disclosure;

FIG. 4 is a schematic of an appendage of an animated figure, wherein the appendage is in a resting state, in accordance with embodiments of the present disclosure;

FIG. 5 is a schematic of granules of a joint restraint device in a compacted state, in accordance with embodiments of the present disclosure;

FIG. 6 is a schematic of granules of a joint restraint device in an uncompacted state, in accordance with embodiments of the present disclosure;

FIG. 7 is a perspective view of a joint restraint device, in accordance with embodiments of the present disclosure;

FIG. 8 is a schematic of control circuitry for operating a joint restraint device, in accordance with embodiments of the present disclosure;

FIG. 9 is a schematic of control circuitry for operating multiple joint restraint devices, in accordance with embodiments of the present disclosure; and

FIG. 10 is a schematic of an appendage control system for an animated figure, in accordance with embodiments of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to an animated figure (e.g., robot) for use in a venue, such as an amusement park. The venue may include an attraction system, such as a theatrical stage, a roller coaster, a car ride, and so forth. For example, the animated figure may entertain guests as part of a theatrical show in which the animated figure exhibits locomotive behavior, environmental sensing, sound effects, and so forth. To enable bodily movement, the animated figure may include one or more joints connecting members of the animated figure. For example, an appendage (e.g., leg) of the animated figure may include a first member (e.g., upper leg portion; femur) and a second member (e.g., lower leg portion; tibia) coupled via a joint (e.g., knee). Motion of the members about the joint may be generated by an actuator, such as a motor, a piston, a servo, an artificial muscle, and the like. The actuator may receive electrical power from a power supply and convert the electrical power into mechanical energy to move the members. In some cases, the actuator may be actively powered to maintain a desired position (e.g., target position) of the members. That is, absent operation of the actuator, the appendage may change (e.g., fall; due to gravity) from the desired position to a different position (e.g., undesired position; a position having lower potential energy). As a result, the animated figure may release the joint from the desired position when the actuator is not in operation.

In certain situations, operation of the actuator may be interrupted, causing the joint to yield. For example, the actuator may experience a loss of electrical power due to an interruption of the power supply, which may cause operation of the actuator to be interrupted. In an embodiment, the animated figure may include a shut-off switch (e.g., emergency stop) configured to shut off supply of electrical power to the actuator. In existing systems (e.g., without embodiments disclosed herein), the resulting interruption to the operation of the actuator may cause the joint to lose hold of the desired position, causing unwanted movement of the animated figure. Additionally, operation of the actuator to maintain the desired position of the animated figure may cost energy, component service life, and/or computational resources. Accordingly, it may be desirable for the desired position of the joint to be sustained without operation of the actuator.

With the foregoing in mind, systems described herein relate generally to a joint restraint system configured to restrict movement of joints of an animated figure. The joint restraint system includes a joint restraint device configured to tighten controllably around a joint and thereby block movement of the joint. Specifically, the joint restraint device includes an enclosure disposed around the joint. The enclosure may be flexible, conforming to a shape of the animated figure at the joint. The enclosure may contain a combination of gas (e.g., air) and granules. When loosely dispersed within the enclosure, the granules are configured to flow between one another with little resistance. However, when the granules are compacted, the granules may jam against one another to form a rigid packing around the joint, thereby blocking motion of the joint. The enclosure may be fluidly coupled, via a valve, to a vacuum source (e.g., vacuum chamber, pump) configured to generate negative pressure within the enclosure. When the valve is opened, the gas may be evacuated from the enclosure, decreasing gas pressure in the enclosure. As a result, a membrane of the enclosure may compact the granules to form a mechanically stable packing around the joint. In an embodiment, activation of the joint restraint device may be triggered by a shut-off switch or other interruption to the operation of the actuator. By holding the joint in a desired position when the actuator is depowered, the joint restraint device may reduce falls of the animated figure, conserve energy, and/or extend service life of components.

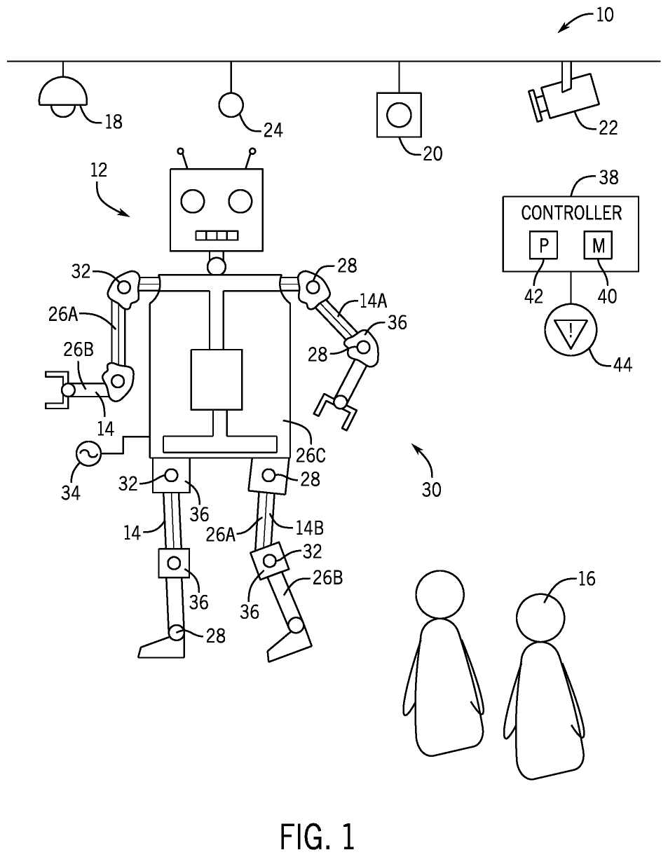

Turning now to the drawings, FIG. 1 illustrates an attraction system 10 that includes an animated FIG. 12. The animated FIG. 12 is configured to move one or more appendages 14 (e.g., an arm 14A, a leg 14B, a tentacle, an implement) to perform programmed actions, interact with guests 16, or otherwise entertain the guests 16. In addition to the animated FIG. 12, the attraction system 10 may include a lighting system 18, a sound system 20, a projection system 22, and/or sensors 24 to enhance an entertainment experience for the guests 16. In an embodiment, the animated FIG. 12 may be configured to perform a theatrical show on a stage, provide an effect during a ride, and/or travel along paths of a venue to interact with the guests 16.

As discussed herein, the appendages 14 may include members 26 that are articulated about joints 28. For example, an arm 14A may include a first member 26A (e.g., upper arm portion) and a second member 26B (e.g., forearm; lower arm portion) coupled (e.g., hinged, rotatably coupled) to one another via a first joint 28 (e.g., elbow). Additionally, the first member 26A may be coupled to a third member 26C (e.g., torso) of the animated FIG. 12 at a second joint 28 (e.g., shoulder). The joints 28 may include hinge joints (e.g., knee, elbow), ball and socket joints (e.g., shoulder), gliding joints (e.g., wrist), and/or another suitable type of joint. Although the animated FIG. 12 is shown to have anthropomorphic appendages 14 and joints 28 (e.g., arms and knees) it should be appreciated that the animated FIG. 12 may not exhibit such humanoid characteristics. For example, the appendages 14 may represent spider legs, sea anemone tentacles, tree branches, implements (e.g., tools) held via arms, abstract geometries, and/or any other generally articulated structure. The description herein of the appendages 14 relates generally to any assembly of members 26 connected by joints 28.

The animated FIG. 12 may include an appendage control system 30 configured to control movement and positioning of the appendages 14 (e.g., joints 28). The appendage control system 30 includes actuators 32 configured to move the appendages 14 about the joints 28. For example, the actuators 32 may include motors, servos, pneumatic actuators, hydraulic actuators, rack and pinions, artificial muscles, and/or soft actuators. The actuators 32 may be coupled to the joints 28 and/or the members 26 directly or via linkage assemblies such that operation of the actuators 32 causes the appendages 14 to move to desired positions. The animated FIG. 12 may include a power supply 34 configured to supply electrical power to the actuators 32. To enhance efficiency and operation of the animated FIG. 12, the appendages 14 may include joint restraint devices 36 to block the joints 28 from moving under certain conditions. For example, the joint restraint devices 36 may lock the joints 28 based on an operating state of the actuators 32, an operating state of the power supply 34, an emergency stop condition, an operator command, and/or sensor feedback. As a result, the position of the animated FIG. 12 may be maintained without relying on active support by the actuators 32.

The attraction system 10 may include a controller 38 including processing circuitry configured to control the animated FIG. 12. In an embodiment, the controller 38 may include a memory 40 and a processor 42. The memory 40 may include a tangible, non-transitory, computer-readable medium that may store instructions that, when executed by the processor 42 may cause the processor 42 to perform various functions described herein. To this end, the processor 42 may be any suitable type of computer processor or microprocessor capable of executing computer-executable code, including but not limited to one or more field programmable gate arrays (FPGA), application-specific integrated circuits (ASIC), programmable logic devices (PLD), programmable logic arrays (PLA), and the like. It should be appreciated that the controller 38 may include or represent a distributed controller or control system with multiple memory devices and/or multiple processors that operate together to carry out techniques described herein (e.g., one processor performs one operation, another processor performs another operation, and so forth). Thus, as used herein, the memory 40 may include one or more memory devices and the processor 42 may include one or more processors.

The controller 38 may control operation of the actuators 32, including controlling a supply of electrical power to the actuators 32. For example, the controller 38 may include circuitry configured to regulate current and/or voltage supplied to the actuators 32 from the power supply 34. In an embodiment, the controller 38 may control the actuators 32 based on commands received from an operator and/or based on preprogrammed instructions (e.g., script). Additionally, the controller 38 may receive sensor input (e.g., from the sensors 24) and operate the actuators 32 based on the sensor input. In addition to controlling the animated FIG. 12, the controller 38 may control other aspects of the attraction system 10, including the lighting system 18, the sound system 20, and/or the projection system 22. The attraction system 10 may include a shut-off switch 44 (e.g., emergency stop) coupled to the controller 38 and/or the power supply 34. The shut-off switch 44 may shut off power to the actuators 32 and/or activate the joint restraint devices 36 under certain conditions.

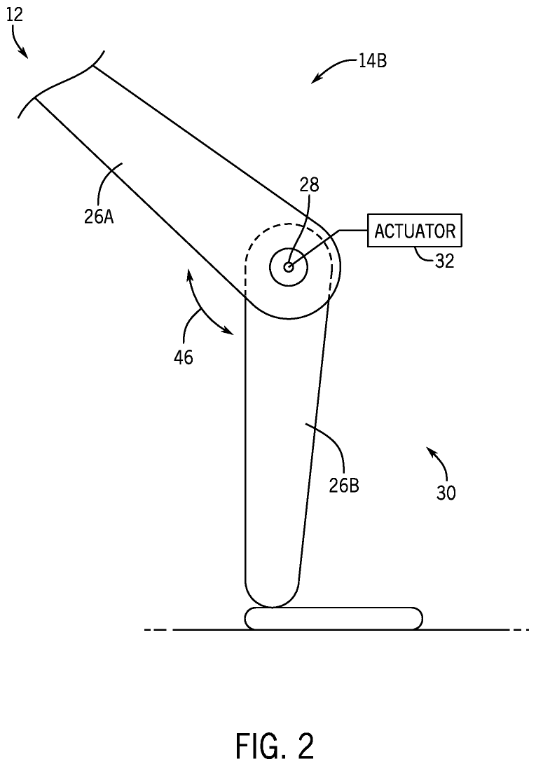

FIG. 2 illustrates an embodiment of one appendage 14 of the animated FIG. 12. In particular, FIG. 2 illustrates an embodiment of the leg 14B of the animated FIG. 12, wherein the leg 14B includes the first member 26A, the second member 26B, and the joint 28. For clarity of the illustration, the joint restraint device 36 is not shown in FIG. 2. The joint 28 may rotatably couple a lower end portion of the first member 26A to an upper end portion of the second member 26B. In this way, the first member 26A and the second member 26B may rotate (e.g., pivot, hinge) relative to one another about the joint 28. The animated FIG. 12 includes the actuator 32, shown to be coupled to the joint 28. For example, the joint 28 may include a shaft defining an axis of rotation of the first member 26A and/or the second member 26B. The actuator 32 may be a motor or a servo configured to rotate the shaft and change an angle 46 between the first member 26A and the second member 26B. In this way, the actuator 32 may control the position of the leg 14B. In an embodiment, the actuator 32 may be coupled to one or both of the first member 26A and the second member 26B. For example, the animated FIG. 12 may include a pulley system, a winch system, a linkage system, or another suitable system for transmitting motion from the actuator 32 to the first member 26A and the second member 26B. The actuator 32 may be a linear actuator, such as a piston (e.g., hydraulic piston, pneumatic piston). The piston may be coupled to a linkage of the leg 14B such that linear motion of the piston is converted to rotational motion about the joint 28.

During normal operation, the actuator 32 may receive electrical power from the power supply 34 (FIG. 1) and generate the force to move the leg 14B or keep the leg 14B stationary (e.g., in a desired position). When the electrical power is not provided, the actuator 32 may not actively generate any force to hold the appendage in a particular static position. For example, the actuator 32 may not actively support the weight of the first member 26A. Therefore, present embodiments include systems to restrain motion of the joint 28 when the actuator 32 is not in operation.

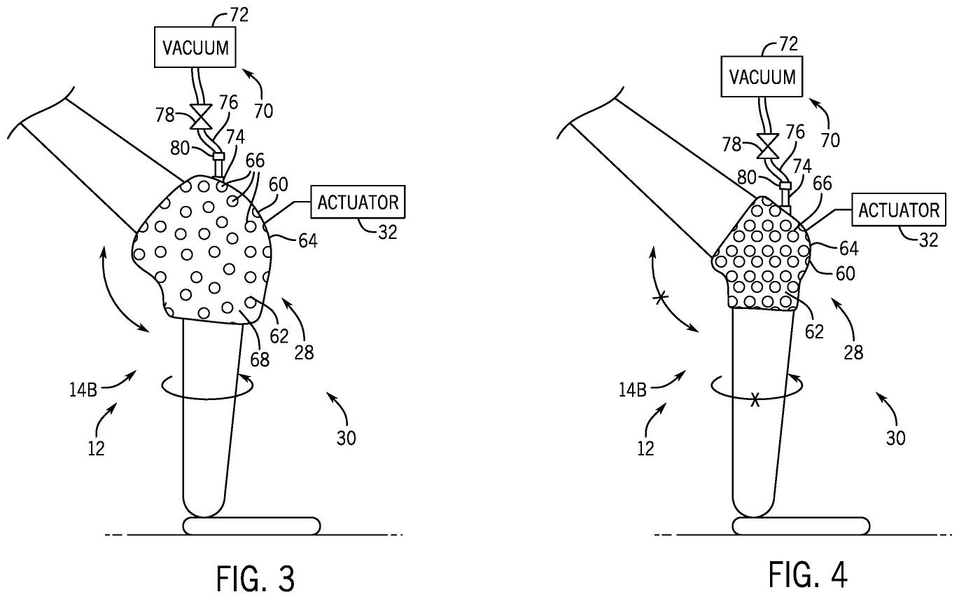

As discussed herein, the appendage control system 30 of the animated FIG. 12 includes a joint restraint device 36. To illustrate the engagement of the joint restraint device 36 (FIG. 3) with the joint 28, FIG. 3 is a schematic of an embodiment of the leg 14B of the animated FIG. 12 in an operational state, where the joint restraint device 36 is not active. The joint restraint device 36 includes an enclosure 60 positioned around the joint 28. The enclosure 60 may be torus-shaped, having an internal volume 62 enclosed by a membrane 64 of the enclosure 60. The internal volume 62 may be annularly disposed around the joint 28. That is, the enclosure 60 may be wrapped around the joint 28. The joint restraint device 36 may include granules 66 (e.g., granular material, particulates) disposed within the internal volume 62. The granules 66 may be solid particles ranging, for example, from 0.01 millimeters to 5 millimeters in length or diameter. When the leg 14B is in the operational state, the enclosure 60 may contain air 68 or another suitable fluid to exert pressure against the membrane 64 of the enclosure. The membrane 64 may be resilient (e.g., elastic, flexible) such that the volume and/or shape of the enclosure 60 changes depending on the air pressure therein. For example, the enclosure 60 may have a different volume and/or shape when the pressure of the air 68 is respectively less than, equal to, or greater than atmospheric pressure.

The joint restraint device 36 may include a pressure control system 70 to control the air pressure within the enclosure 60. The pressure control system 70 may include a vacuum source 72 fluidly coupled to an outlet 74 of the enclosure 60 via a conduit 76 (e.g., airflow conduit, tube, hose). The vacuum source 72 contains a vacuum (e.g., low-pressure environment) within a container (e.g., rigid enclosure) from which air is removed (e.g., by a vacuum pump). Due to a pressure difference between the vacuum source 72 and the enclosure 60, the vacuum source 72 may suck the air 68 from the enclosure 60 to the vacuum source 72 via the conduit 76. The pressure control system 70 may also include a valve 78 configured to regulate a flow of the air 68 between the enclosure 60 and the vacuum source 72. During normal operation (e.g., with the leg 14B in the operational state), the valve 78 may be closed to block the air 68 in the enclosure 60 from exiting the enclosure 60, thereby maintaining the pressure difference across the valve 78. In an embodiment, the valve 78 may be normally open, requiring an electrical input to remain closed. For example, the valve 78 may receive power from the power supply 34 or an additional power supply during normal operation. If the power to the valve 78 is interrupted, the valve 78 may automatically open, enabling the air 68 to flow from the enclosure 60 toward the vacuum source 72. In an embodiment, the valve 78 may operate according to signals (e.g., instructions) provided by the controller 38. For example, the controller 38 may instruct the valve 78 to remain closed or to open based on an operator input (e.g., via remote control), an operating condition (e.g., a fault), a sensor input, a scripted (e.g., timed, pre-programmed) operation. For example, during a show performance, the controller 38 may instruct the valve 78 to open and thereby seize the position of the joint 28, even if power to the valve 78 is not interrupted. In this way, an operator may provide an input to operate the valve 78 (e.g., to store the animated figure, to maintain a position during a show, between ride cycles, etc.).

The joint restraint device 36 may also include a filter 80 configured to block the granules 66 from exiting the enclosure 60, entering the conduit, and/or entering the vacuum source 72. In this way, the granules 66 may be contained within the enclosure 60 while the air 68 is allowed to flow through the valve 78. The filter 80 may be disposed at the outlet 74 of the enclosure, within the conduit 76, and/or at an inlet of the vacuum source 72. In an embodiment, the vacuum source 72 may be coupled to the animated FIG. 12, and multiple joint restraint devices 36 (e.g., of multiple appendages 14) may be fluidly coupled to the vacuum source 72.

When the leg 14B is in the operational state, the joint restraint device 36 may be inactive to enable the joint 28 to move. When the leg 14B is in the operational state, the enclosure 60 may contain a relatively high air pressure (e.g., a positive air pressure, greater than a threshold air pressure). Thus, the volume of the enclosure 60 may be relatively large as the air 68 applies pressure outward against the membrane 64. In an uncompacted state, the granules 66 may exhibit granular flow as the joint 28 moves. That is, the granules 66 may move freely through and/or past each other in a fluid-like manner. As a result, the shape of the enclosure 60 may be conformable to the geometry and motion of the joint 28. For example, the joint restraint device 36, being flexibly engaged with the joint 28, may not inhibit the range of motion of the joint 28 (e.g., may allow the joint 28 to move to perform instructed and/or desired motions). To accommodate movement of the joint 28, the granules 66 may flow freely within the internal volume 62 of the enclosure as the shape of the enclosure 60 changes to conform with the joint 28.

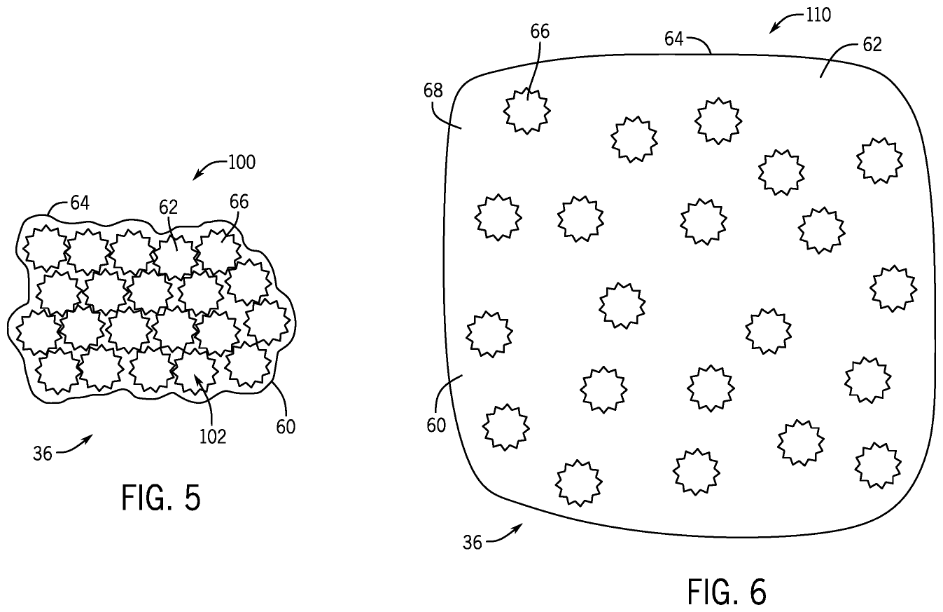

FIG. 4 is a schematic of an embodiment of the leg 14B in a resting state, where the joint restraint device 36 (FIG. 4) is active. The resting state may result from an interruption to normal operation of the animated FIG. 12, such as a power loss or activation of the shut-off switch. In an embodiment, the leg 14B may adopt the resting state during normal operation to maintain the position of the joint 28 without sustaining operation of the actuator 32. In the resting state, the joint restraint device 36 may activate to block movement of the joint 28. For example, the valve 78 may be opened, causing the air 68 to be sucked from the enclosure 60 toward the vacuum source 72, creating a low-pressure environment (e.g., vacuum) within the enclosure 60. As a result, the internal volume 62 of the enclosure 60 may collapse under ambient pressure (e.g., atmospheric pressure), causing the granules 66 to become compacted against each other. For example, the membrane 64 of the enclosure 60 may be configured to contract inward and squeeze the granules 66 together. In a compacted state, the granules 66 may press against one another (e.g., compress to contact one another or to pack tightly together), blocking the granular flow discussed herein with respect to the granules 66. In an embodiment, the controller 38 may detect an interruption of power to the actuator 32 and, in response, automatically open the valve 78 to compact the granules 66 against each other and block movement of the joint 28. The engagement of the granules is discussed in further detail herein with respect to FIG. 5.

FIG. 5 shows a detailed view of an embodiment of the granules 66 in a compacted state 100 (e.g., jammed state) within the enclosure 60. As shown, the granules 66 are compacted into dense contact with one another to form a rigid mass 102. The rigid mass 102 is held together by the membrane 64 compressing the granules 66 via the vacuum pressure created by the pressure control system 70. Frictional and interlocking interactions between the granules 66 may block granular flow, inhibiting movement of the granules 66 past one another. As a result, the shape of the rigid mass 102 is solidified (e.g., stiffened). In an embodiment, the granules 66 may have geometric properties to promote the frictional and interlocking engagements to each other. For example, the granules 66 may have jagged edges, concave surfaces, convex surfaces, holes, branches, and/or various sizes. The rigid mass 102 may be solidified around the joint 28 to inhibit movement of the joint 28.

FIG. 6 shows a detailed view of an embodiment of the granules 66 in an uncompacted state 110 (e.g., unjammed state) within the enclosure 60. In the uncompacted state 110, the granules 66 are less densely arranged, which enables the granules 66 to flow in a fluid-like manner. As a result, the granules 66 do not form a rigid mass, and the membrane 64 is free to conform to external geometries, such as surfaces of the appendage 14. For example, during the operational state of the leg 14B, the enclosure 60 may conform to envelop the joint 28 without inhibiting motion of the joint 28. As the joint 28 moves, the granules 66 may flow within the membrane 64, and the membrane 64 itself may change shape to conform to the position of the joint 28. Then, in the compacted state 100, the membrane 64 may compress the granules 66 together to form the rigid mass 102 in a shape conformed to the joint 28 in the resting state. As a result, the frictional and interlocking interactions between the granules 66 may restrict movement of the joint 28. The granules 66 may be coffee grounds, three-dimensional (3D) printed particles (e.g., formed via a 3D printer), polymer beads, and/or any suitable granular or particulate material.

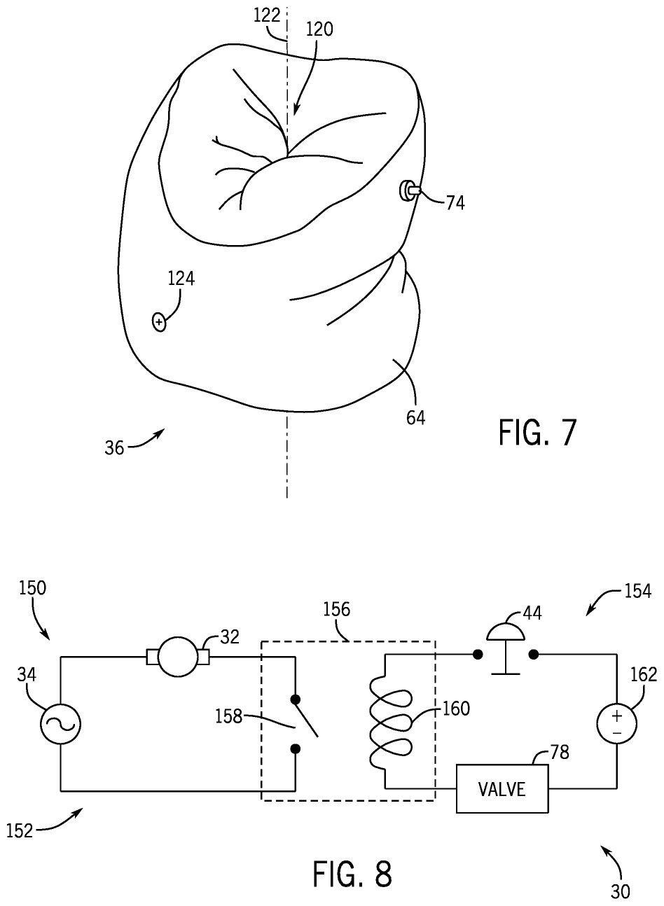

FIG. 7 illustrates a perspective view of the joint restraint device 36. The membrane 64 may be shaped like a ring or a sleeve configured to wrap around the joint 28. For example, the membrane 64 may be torus-shaped with a hole 120 along a central axis 122. The membrane 64 may be fitted over the appendage 14 through the hole 120, and the joint 28 may be at least partially enclosed within the membrane 64. The joint restraint device 36 includes the outlet 74 (e.g., nozzle), configured to be coupled to the conduit 76 shown in FIGS. 3 and 4. In an embodiment, the air 68 may be introduced to the enclosure via the outlet 74. The joint restraint device 36 may also include a granule inlet 124 that provides an opening for inserting and removing the granules from the enclosure 60.

FIG. 8 illustrates an embodiment of control circuitry 150 for operating the joint restraint device 36. The control circuitry 150 includes a power circuit 152 and a relay circuit 154 coupled via a relay 156. The power circuit 152 includes the power supply 34 (e.g., AC power supply) connected to the actuator 32. The relay 156 may be a mechanical relay having a switch 158 (e.g., normally open switch) connected in series with the power circuit 152. That is, the switch 158 is configured to close and open the power circuit 152, effectively controlling power to the actuator 32. The relay 156 may also include an electromagnet 160 configured to close the switch 158 upon energization of the electromagnet 160. The electromagnet 160 may be connected in series with the relay circuit 154. That is, current in the relay circuit 154 may energize the electromagnet 160, causing the relay 156 to close the switch 158 and supply power to the power circuit 152 (e.g., the actuator 32).

The relay circuit 154 includes an additional power supply 162 (e.g., DC power supply, auxiliary power supply) connected to the valve 78. Additionally, the valve 78, the power supply 34, and/or the electromagnet may be connected in series with the shut-off switch 44. The shut-off switch 44 may be configured to close and open the relay circuit 154. During normal operation, the shut-off switch 44 may be closed, enabling the additional power supply 162 to energize the electromagnet 160 and to power the valve 78. When powered by the additional power supply, the valve 78 may close a flow of air between the vacuum source 72 and the enclosure 60, thereby maintaining a pressure difference across the valve 78. For example, with reference to FIG. 3, during the operating state of the leg 14B, when the shut-off switch 44 is closed, the enclosure 60 may contain the air 68, and the valve 78 may remain closed to maintain a positive air pressure within the enclosure 60.

In some situations, the shut-off switch 44 may be opened as a method of depowering the actuator 32. For example, the shut-off switch 44 may be an emergency stop button, and an operator may open (e.g., push) the shut-off switch 44 to stop operation of the animated FIG. 12. When the shut-off switch 44 is opened, the electromagnet 160 may be de-energized, and the relay 156 may close the switch 158 to shut off power from the power supply 34 to the actuator 32. Simultaneously, opening the shut-off switch 44 may shut off the power from the additional power supply 162 to the valve 78, causing the valve 78 to open. As a result, with reference to FIG. 4, vacuum pressure may be released from the vacuum source 72 to the enclosure 60, causing the membrane 64 to compress around the granules 66 and causing the granules to compact against each other to the compacted state 100. In this way, the joint restraint device 36 may restrain (e.g., lock) the joint 28 from moving while the actuator 32 is depowered. In an embodiment, the relay 156 may be an electrical relay (e.g., solid state relay, metal-oxide-semiconductor field-effect transistor (MOSFET) relay) controlled by the controller 38 or another processor.

In an embodiment, the shut-off switch 44 may be utilized generally as an operator-actuated input to control the valve 78 to thereby enable the operator to maintain the animated FIG. 12 in a particular position (e.g., for storage, for parts of a show, in between ride cycles, etc.). Additionally, the valve 78 may be operated via the controller 38. For example, the controller 38 may transmit signals (e.g., instructions) to the valve 78 to remain closed or to open. The controller 38 may generate the signals in response to an operator input, a sensor input, an operating condition, a scripted (e.g., preprogrammed) operation, or another suitable input.

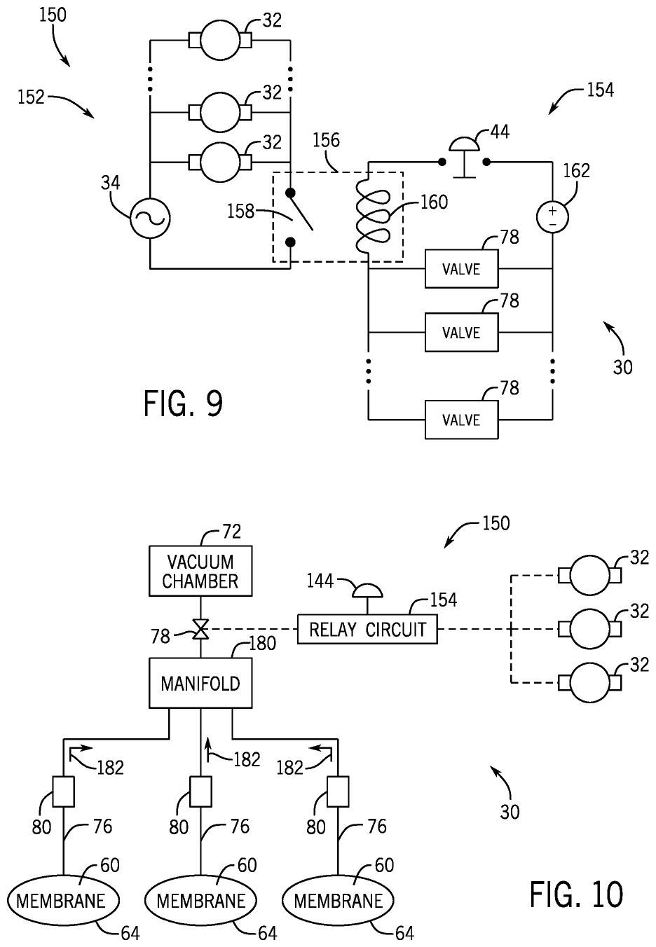

FIG. 9 illustrates an embodiment of the control circuitry 150 controlling multiple actuators 32 and valves 78. For example, the animated FIG. 12 may include a respective actuator 32 and valve 78 for each appendage 14. The control circuitry 150 may enable the relay circuit 154 to shut down multiple actuators 32 and open multiple valves 78 based on opening of the shut-off switch 44. As shown, the multiple actuators 32 may be connected in parallel with one another and in series with the power supply 34 and the relay 156 (e.g., switch 158). Additionally, the multiple valves 78 may be connected in parallel with one another and in series with the additional power supply 162, the relay 156 (e.g., electromagnet 160), and the shut-off switch 44. Each of the multiple valves 78 may also be controlled via the controller 38. The controller 38 may instruct each of the multiple valves 78 to operate independently of one another or in coordination (e.g., simultaneously) with one another. In this way, an operator may control the multiple valves 78, even if power is not interrupted.

In an embodiment, one valve 78 may control the air pressure of multiple joint restraint devices 36 (e.g., enclosures 60). For example, FIG. 10 is a schematic of an embodiment of the appendage control system 30 having one valve 78 configured to regulate the air pressure within multiple enclosures 60. Specifically, each enclosure 60 may be fluidly coupled to a manifold via respective conduits 76. Filters 80 may be disposed along each conduit 76 to block the granules 66 from leaving the membranes 64. The manifold 180 may be fluidly coupled to the vacuum source 72, and the valve 78 may be disposed between the manifold 180 and the vacuum source 72. The conduits 76 may establish air flow paths 182 extending from each of the enclosures 60 to the manifold 180, where the air flow paths 182 may join and connect to the vacuum source 72. The valve 78 may selectively open the vacuum source 72 to the manifold 180 to apply vacuum pressure to the membranes 64 together (e.g., simultaneously). In this way, multiple joints 28 of the animated FIG. 12 may seize and be held to maintain a position of the animated FIG. 12. Advantageously, this may also block collapse of the animated FIG. 12, which may reduce damage to components of the animated FIG. 12, maintain a clear area around the animated FIG. 12, and/or enable the animated FIG. 12 to continue to be visible and/or provide entertainment to guests, for example.

While certain examples herein related to the animated FIG. 12 within the attraction system 10 have been described, it should be appreciated that embodiments may be utilized in any of a variety of environments and in any of a variety of contexts. For example, the animated FIG. 12 may be utilized within any of a variety of venues, such as theatres, stadiums, schools, restaurants, hotels, shops, and so forth. Further, the animated FIG. 12 may be utilized for any of a variety of purposes, such as to entertain guests, provide education, carry out and/or assist with performance of tasks, and so forth.

While only certain features of the invention have been illustrated and described herein, many modifications and changes will occur to those skilled in the art. It is, therefore, to be understood that the appended claims are intended to cover all such modifications and changes as fall within the true spirit of the invention. It should be appreciated that any features shown in FIGS. 1-10 or described with reference to FIGS. 1-10 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An animated figure, comprising:
an appendage comprising a joint; and
a joint restraint device coupled to the appendage, the joint restraint device comprising a membrane defining an internal volume and a plurality of granules disposed within the internal volume, wherein the joint restraint device is configured to compact the plurality of granules against each other to restrain motion of the joint in response to a vacuum pressure applied to the membrane.

2. The animated figure of claim 1, comprising an actuator configured to move the appendage about the joint.

3. The animated figure of claim 2, comprising a vacuum source fluidly coupled to the internal volume of the membrane, wherein the vacuum source is configured to apply vacuum pressure to the internal volume.

4. The animated figure of claim 3, comprising:
a conduit fluidly coupling the vacuum source to the membrane; and
a valve disposed along the conduit, wherein the valve is configured to selectively open to enable air to flow from the membrane toward the vacuum source.

5. The animated figure of claim 4, comprising control circuitry configured to simultaneously depower the actuator and open the valve.

6. The animated figure of claim 5, comprising:
a power supply configured to supply power to the actuator; and
a relay circuit comprising a shut-off switch in series with an additional power supply, wherein the relay circuit is configured to shut off the power supplied to the actuator, and allow power from the additional power supply to open the valve when the shut-off switch is opened.

7. The animated figure of claim 6, wherein the shut-off switch is configured to be actuated via a controller of the animated figure.

8. The animated figure of claim 4, comprising a filter disposed along the conduit, wherein the filter is configured to block the granules from flowing through the conduit.

9. The animated figure of claim 1, wherein the plurality of granules is configured to flow within the internal volume of the membrane in a relatively uncompacted state without the vacuum pressure applied to the internal volume and to a compacted state against each other when the vacuum pressure is applied to the internal volume.

10. The animated figure of claim 1, wherein the plurality of granules is configured to form a relatively rigid mass around the joint in response to the vacuum pressure being applied to the internal volume.

11. The animated figure of claim 1, wherein the membrane is torus-shaped.

12. The animated figure of claim 1, wherein the membrane is annularly disposed about the joint.

13. A joint restraint device for an animated figure, the joint restraint device comprising:
a membrane defining an internal volume;
a conduit configured to fluidly couple the internal volume to a vacuum source;
a valve configured to selectively open an air flow path between the internal volume and the vacuum source via the conduit; and
a plurality of granules disposed within the internal volume of the membrane, wherein the plurality of granules is configured to compact against each other to form a relatively rigid body in response to a vacuum pressure applied to the internal volume.

14. The joint restraint device of claim 13, wherein the membrane is configured to wrap around a joint of the animated figure.

15. The joint restraint device of claim 14, wherein the animated figure includes an actuator configured to move an appendage relative to the joint, and the valve is configured to open in response to an interruption of power to the actuator.

16. The joint restraint device of claim 15, comprising:
a relay circuit configured to:
selectively enable current to flow from a power supply to the actuator; and
direct power from an additional power supply to the valve; and
a shut-off switch configured to selectively open the relay circuit.

17. An appendage control system for an animated figure, the appendage control system comprising:
a plurality of actuators, wherein each actuator of the plurality of actuators is configured to move a respective appendage relative to a respective joint of the animated figure;
a plurality of joint restraint devices, wherein each joint restraint device of the plurality of joint restraint devices comprises:
a resilient membrane defining an internal volume; and
a plurality of granules disposed within the internal volume, wherein the plurality of granules is configured to form a relatively rigid body around a respective joint of the plurality of joints in response to a vacuum pressure applied to the internal volume.

18. The appendage control system of claim 17, comprising:
a vacuum source and a valve configured to selectively open an air flow path between each respective internal volume of the plurality of joint restraint devices and the vacuum source.

19. The appendage control system of claim 18, wherein the valve is configured to open based on a supply of power to the plurality of actuators.

20. The appendage control system of claim 18, comprising a shut-off switch, wherein power to the plurality of actuators is shut off and the valve is configured to open when the shut-off switch is open.
